(19) United States
(12) Patent Application Publication
(10) Pub. No.: US 2009/0282956 A1
(43) Pub. Date: Nov. 19, 2009

(54) TURRET LATHE

(76) Inventor: Ching-Hui Kuo, Miaoli (TW)

Correspondence Address: SAM CHEN, 7F-1, 293, ROOSEVELT ROAD, SEC 3, TAIPEI, TW

(21) Appl. No.: 12/119,512

(22) Filed: May 13, 2008

(51) Int. Cl. B23B 29/00

(52) U.S. Cl. 82/159

(57) ABSTRACT

A turret lathe includes a bed having a chip pan, parallel bed ways, a first motor on the bed, a sliding carriage on the bed ways driven by the first motor for translating the carriage in a first direction, the carriage having a gable guard above the bed ways, and a second motor; a turret assembly slidably mounted on the carriage and driven by the second motor for translating the turret assembly in a second direction perpendicular to the first direction; an L-shaped headstock including a first chuck and a third motor at an open end of the horizontal portion; and a tailstock including a second chuck aligned with the first chuck, a second slide, a threaded shaft through the second slide to rotatably connect to the third motor, and two parallel racks between the second slide and the horizontal portion of the headstock.

### BACKGROUND OF THE INVENTION

1. Field of Invention

The invention relates to turret lathes and more particularly to such a turret lathe with improved characteristics including opposite chucks, chips directly falling into chip pan, etc.

2. Description of Related Art

Chip removal has always been an important issue in the design phase of lathe. Also, workpiece fastening has always been an important issue to be considered in the design phase of lathe. Moreover, how to effect smooth rectilinear movements along one straight line and along the other straight line perpendicular thereto on a horizontal plane has always been an important issue to be considered in the design phase of lathe.

There have been numerous suggestions in prior patents for turret lathe with chip removal mechanism. For example, U.S. Pat. No. 5,025,690 and U.S. Pat. No. 4,006,518 both discloses a turret lathe. Thus, continuing improvements in the exploitation of turret lathe are constantly being sought.

### SUMMARY OF THE INVENTION

It is therefore one object of the invention to provide a turret lathe comprising opposite chucks for effecting a reliable fastening of a workpiece, a chip removal mechanism for cause chips to be able to directly fall into a chip pan, and a tailstock capable of effecting smooth rectilinear movements along one straight line and along the other straight line perpendicular thereto on a horizontal plane.

The above and other objects, features and advantages of the invention will become apparent from the following detailed description taken with the accompanying drawings.

### BRIEF DESCRIPTION OF THE DRAWINGS

FIG. 1 is a perspective view of a first preferred embodiment of turret lathe according to the invention;

FIG. 2 is an exploded view of the turret lathe;

FIG. 3 is an enlarged view of the tailstock shown in the top right portion of FIG. 2;

FIG. 4 is a view similar to FIG. 1 showing the turret lathe in machining operation;

FIG. 5 is a perspective view of a second preferred embodiment of turret lathe according to the invention;

FIG. 6 is an exploded view of the turret lathe of FIG. 5;

FIG. 7 is an enlarged view of the tailstock shown in the top right portion of FIG. 6; and

FIG. 8 is a view similar to FIG. 5 showing the turret lathe in machining operation.

### DETAILED DESCRIPTION OF THE INVENTION

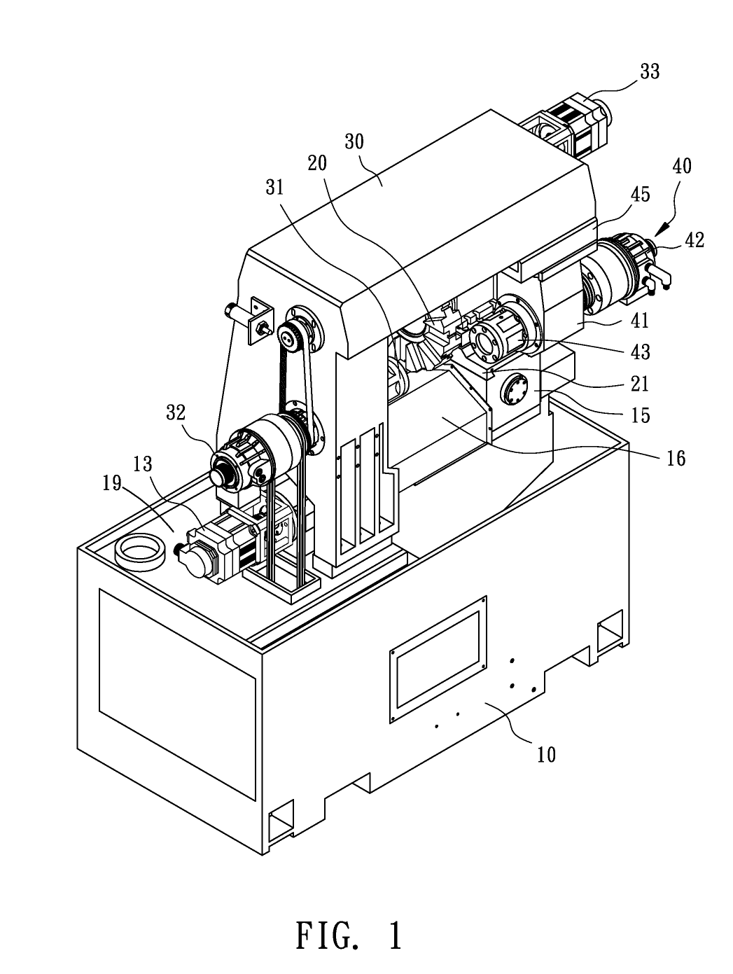

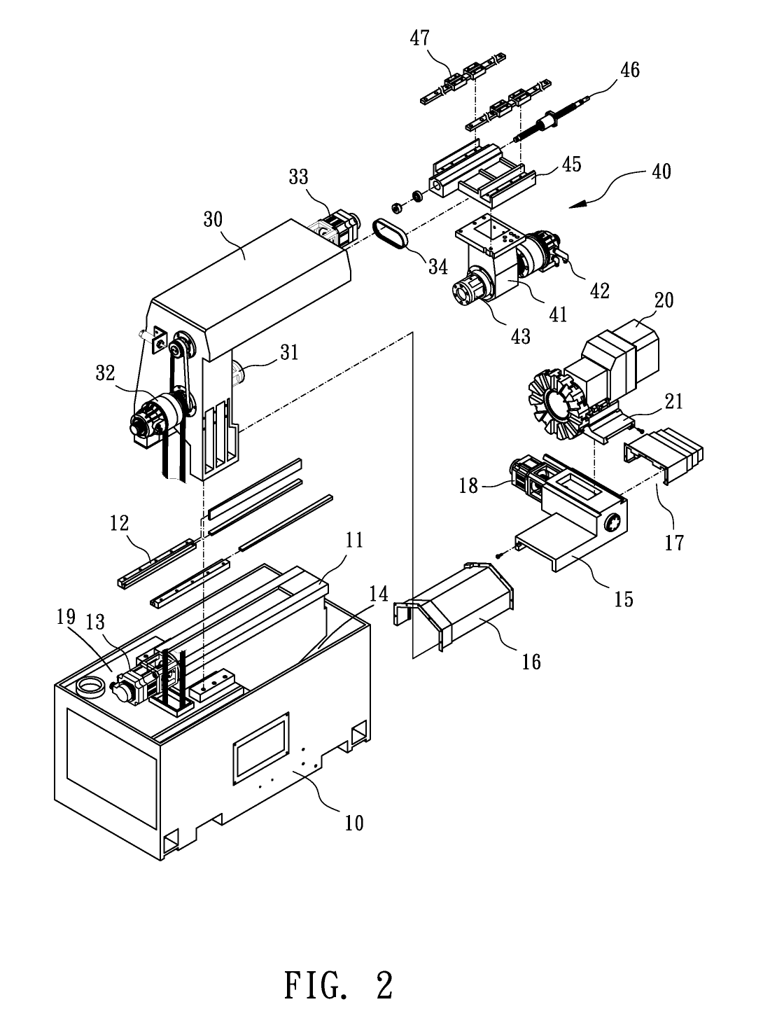

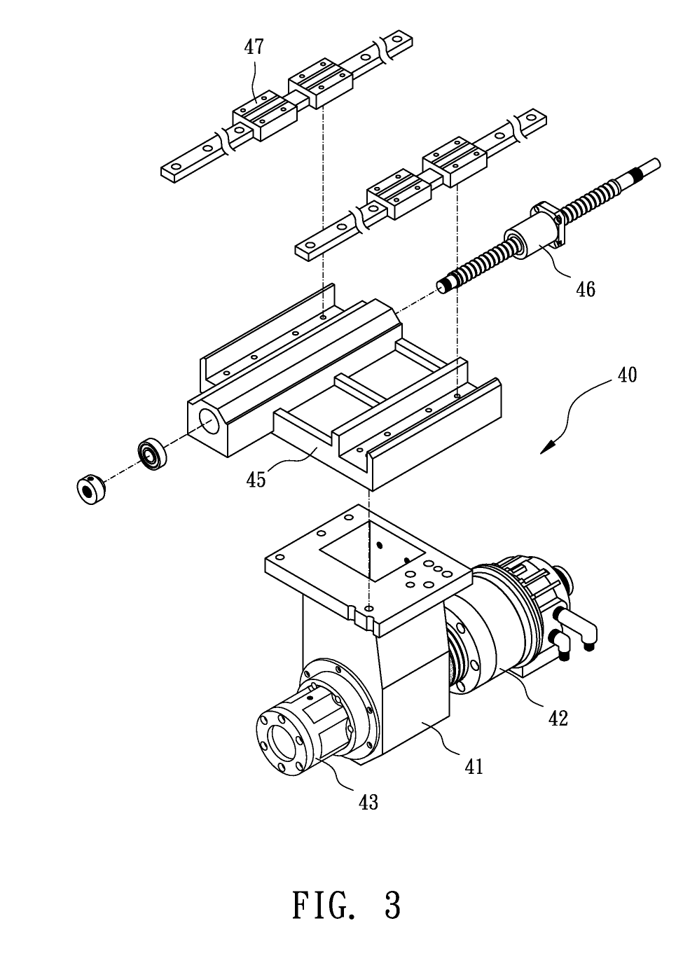

Referring to FIGS. 1 to 4, a turret lathe in accordance with a first preferred embodiment of the invention comprises components as discussed in detail below.

A stand 10 is mounted on the ground. A turret assembly 20 is provided on a bed 19 on the top of the stand 10. An L-shaped headstock 30 is provided on the bed 19. A tailstock 40 is provided under the horizontal portion of the headstock 30.

A chip pan 14 is formed on the bed 19. Chip removal equipment (not shown) for removing collected chips is provided in the chip pan 14. A raised seat 11 is provided besides the chip pan 14. Two parallel bed ways 12 are provided on the seat 11. Note that the moving direction of the turret assembly 20 along the bed ways 12 is defined as Z-axis. A first servo motor 13 is provided at one end of the seat 11. A carriage 15 is slidably provided on the bed ways 12 and is driven by the first servo motor 13. A first guard 16 having a gabled top and a telescopic second guard 17 are provided at both ends of the carriage 15. The provision of the guards 16, 17 not only can prevent chips from falling onto the bed ways 12 in machining operation but also can guide chips into the chip pan 14. A second servo motor 18 is provided at the other side of the carriage 15.

The turret assembly 20 has an X-axis slide 21 on the bottom. The X-axis slide 21 is slidably provided on two parallel ways (not numbered) on the top of the carriage 15 and is driven by the second servo motor 18. Thus, the turret assembly 20 driven by the second servo motor 18 is adapted to move along X-axis (i.e., the moving direction perpendicular to the Z-axis on the horizontal plane). That is, the turret assembly 20 is adapted to translate rectilinearly either in Z-axis direction when the first servo motor 13 activates or in X-axis direction when the second servo motor 18 activates.

The horizontal portion of the headstock 30 is above the chip pan 14 by a distance. A first chuck 31 is extended from the vertical portion of the headstock 30 to be disposed above the chip pan 14. A first hydraulic cylinder 32 is provided on the vertical portion of the headstock 30 opposite the first chuck 31. The first hydraulic cylinder 32 can activate to cause the first chuck 31 to clamp one end of a workpiece (not shown). A third servo motor 33 is provided at an open end of the horizontal portion of the headstock 30. The third servo motor 33 is adapted to drive the tailstock 40 via a belt 34.

The tailstock 40 comprises a housing 41, a second chuck 43 provided at one end of the housing 41 aligned with the first chuck 31, and a second hydraulic cylinder 42 provided at the other end of the housing 41. The second hydraulic cylinder 42 can activate to cause the second chuck 43 to clamp the other end of the workpiece which has one end being clamped by the first chuck 31.

The tailstock 40 further comprises a Z-axis slide 45 fixedly provided on the top of the housing 41, a threaded shaft 46 through the Z-axis slide 45 rotatably secured to the third servo motor 33, and two parallel racks 47 on both sides of the Z-axis slide 45. The racks 47 are also provided on the bottom of the horizontal portion of the headstock 30 so that the Z-axis slide 45 (i.e., the tailstock 40) can translate rectilinearly along the Z-axis to cause the second chuck 43 to clamp the other end of the workpiece when the third servo motor 33 activates in machining operation.

Most importantly, the turret assembly 20 and the tailstock 40 are disposed above the chip pan 14 so that the chip pan 14 may collect chips machined from a workpiece without being interfered. Further, the second chuck 43 can be manipulated to translate rectilinearly so as to clamp the other end of the workpiece which has one end being clamped by the first chuck 31. In brief, it is envisaged by the invention that both lathe removal and workpiece clamping are done successfully.

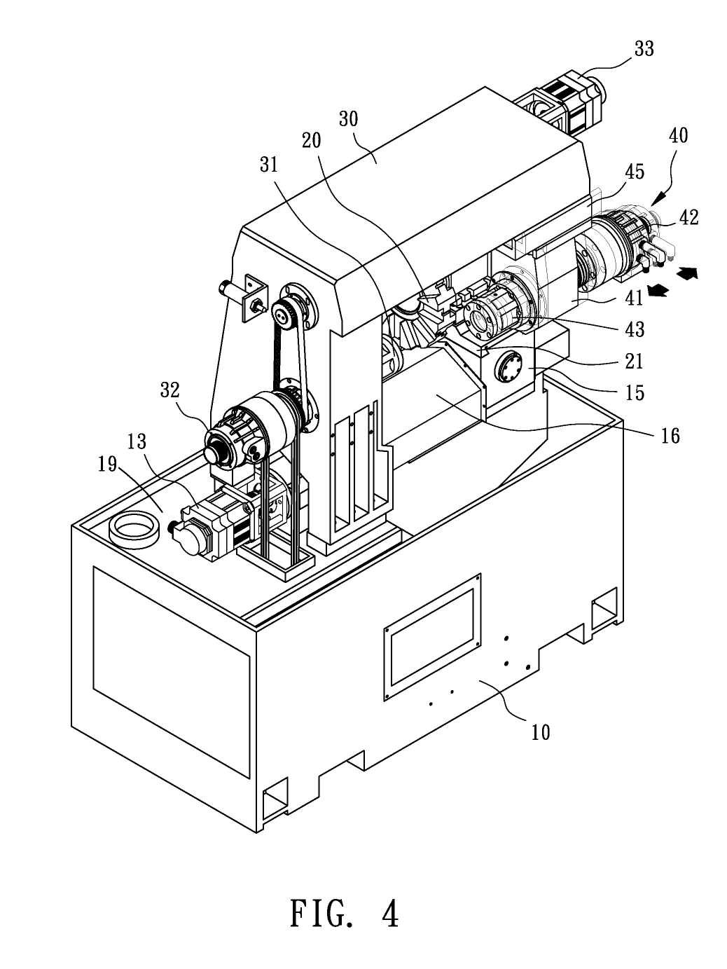

As shown in FIG. 4, a machining operation of the invention will be described in detail below. After clamping one end of the workpiece by the first chuck 31, an operator may activate the third servo motor 33 to rotate the threaded shaft 46. And in turn, the Z-axis slide 45 moves along the racks 47 until the second chuck 43 clamps the workpiece. This double clamping configuration can ensure a high reliability when the workpiece rotates in high speed, thereby increasing accuracy. Moreover, chips machined from the workpiece may fall directly onto the chip pan 14. Hence, the machining operation will not be interfered undesirably.

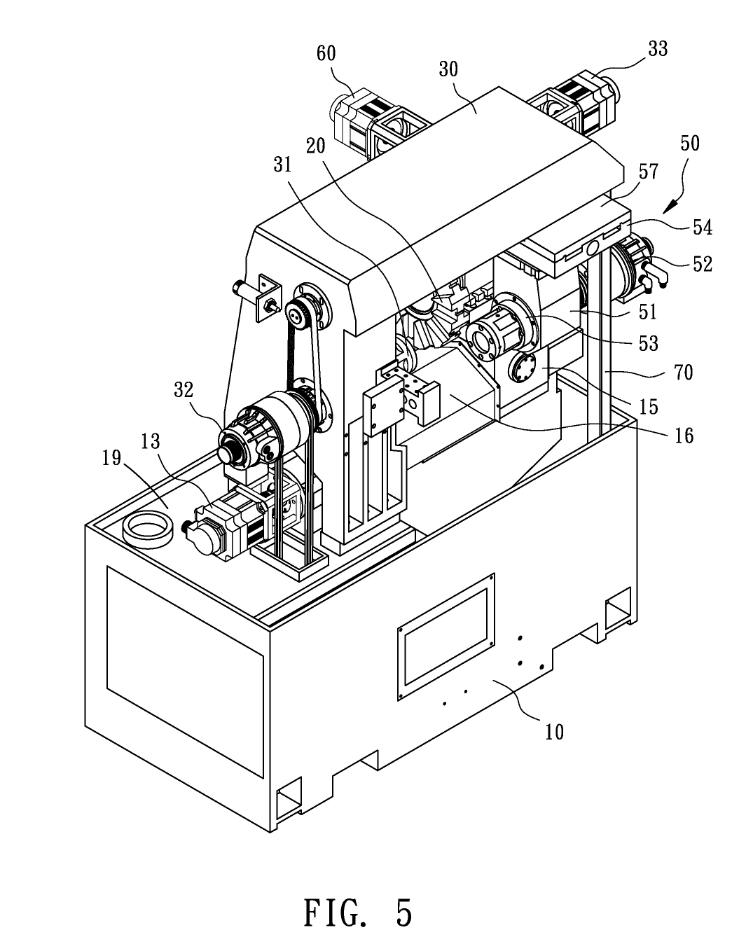

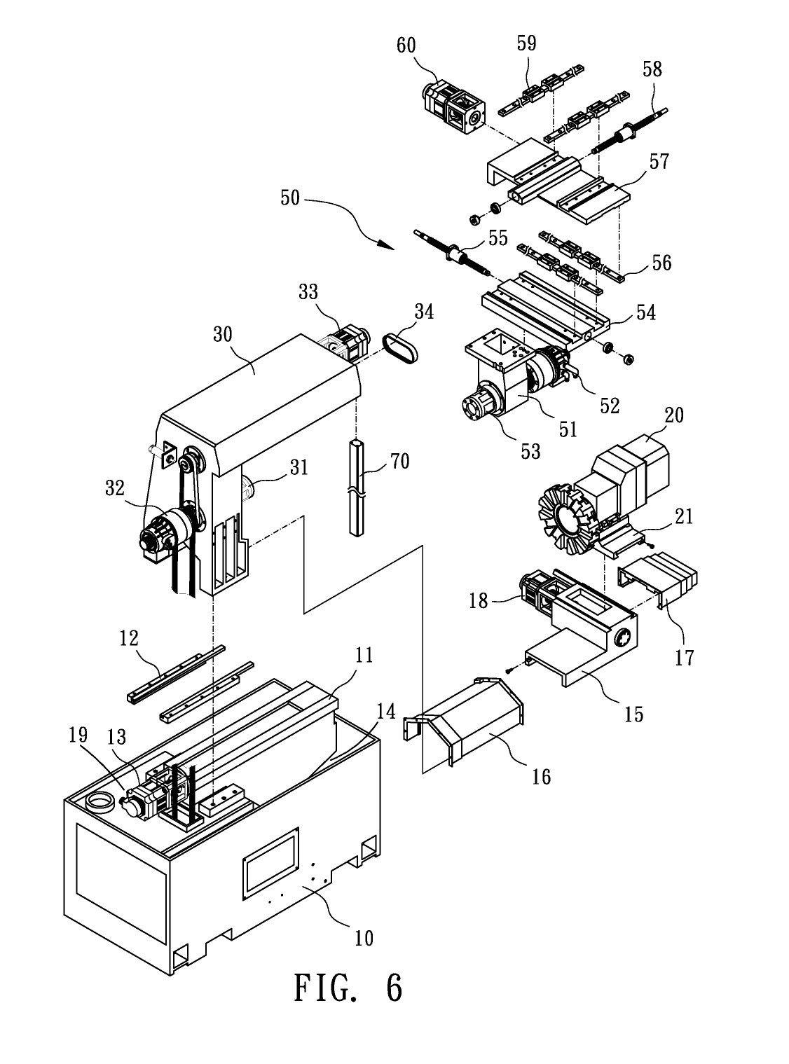

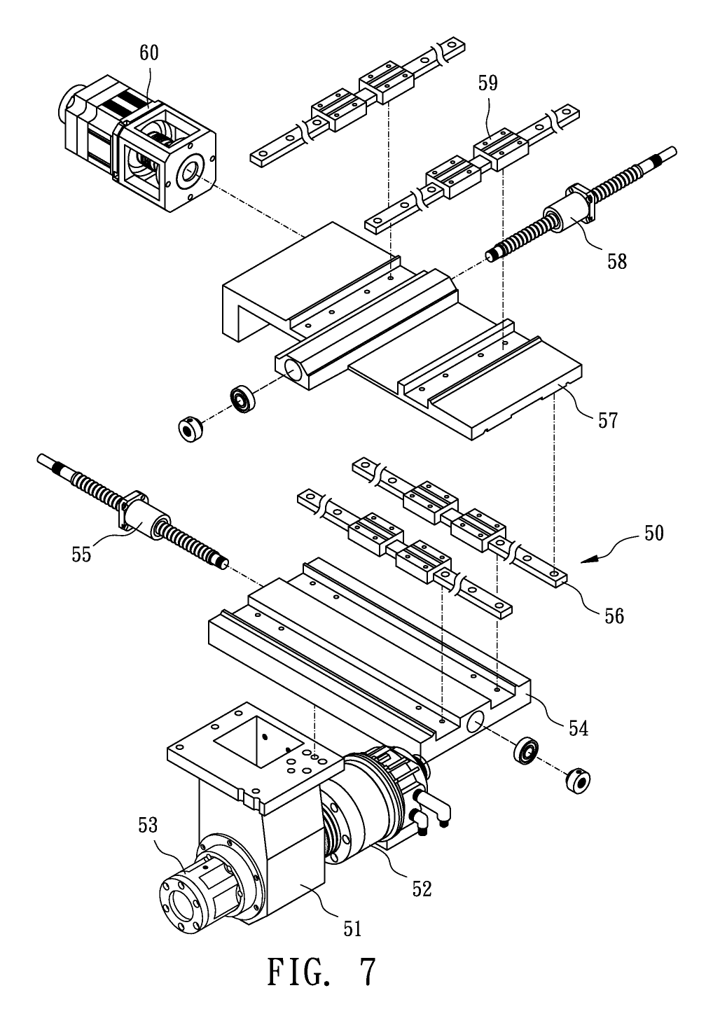

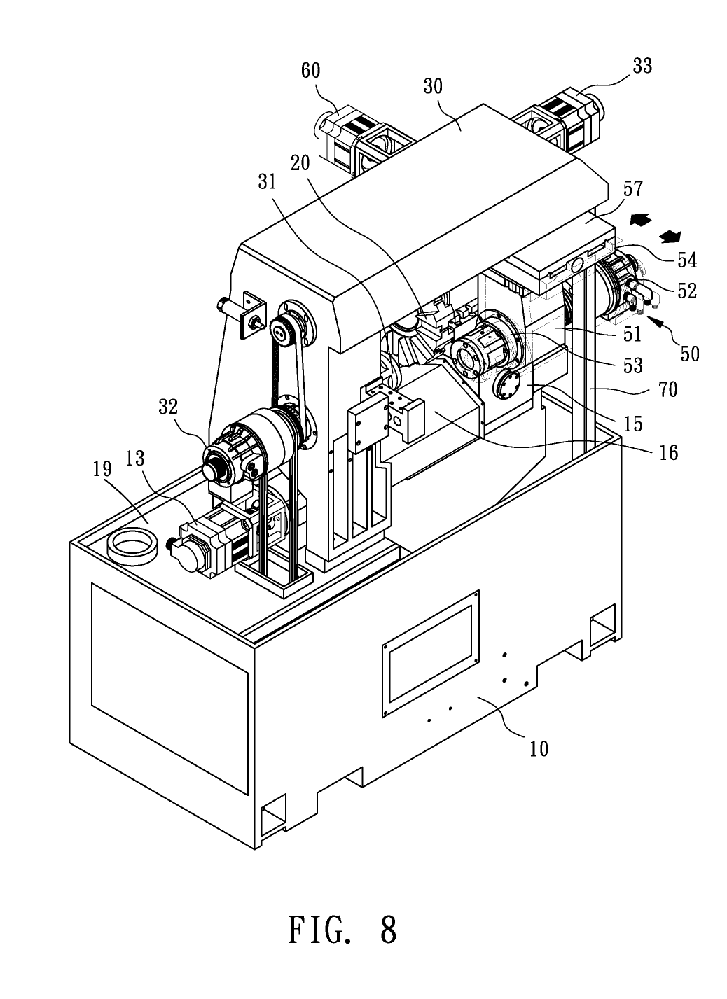

Referring to FIGS. 5 to 8, a turret lathe in accordance with a second preferred embodiment of the invention is shown. The characteristics of the second preferred embodiment are detailed below. The tailstock 50 comprises a housing 51, a second chuck 53 provided at one end of the housing 51 aligned with the first chuck 31, and a second hydraulic cylinder 52 provided at the other end of the housing 51. The second hydraulic cylinder 52 can activate to cause the second chuck 53 to clamp the other end of the workpiece which has one end being clamped by the first chuck 31.

The tailstock 50 further comprises an X-axis slide 54 fixedly provided on the top of the housing 51, a first threaded shaft 55 through the X-axis slide 54, two parallel first racks 56 on the X-axis slide 54, a Z-axis slide 57 moveably provided on the first racks 56, a second threaded shaft 58 through the Z-axis slide 57 rotatably secured to the third servo motor 33, and two parallel second racks 59 on both sides of the Z-axis slide 57. The second racks 59 are also provided on the bottom of the horizontal portion of the headstock 30.

The tailstock 50 further comprises a fourth servo motor 60 at the other side of the Z-axis slide 57. The fourth servo motor 60 is adapted to drive the first threaded shaft 55 so as to cause the X-axis slide 54 to translate rectilinearly along the X-axis in machining operation. Moreover, the third servo motor 33 is adapted to drive the second threaded shaft 58 so as to cause the Z-axis slide 57 to translate rectilinearly along the Z-axis in machining operation.

Further, a column 70 is between the open end of the horizontal portion of the headstock 30 and the bed 19. The column 70 is adapted to give an increased support to the horizontal portion of the headstock 30 so as to prevent the headstock 30 from vibrating abnormally in machining operation.

While the invention herein disclosed has been described by means of specific embodiments, numerous modifications and variations could be made thereto by those skilled in the art without departing from the scope and spirit of the invention set forth in the claims.

What is claimed is:

1. A turret lathe comprising:
a support structure (10) including a top bed (19) having a chip pan (14), a raised seat (11) disposed besides the chip pan (14), two parallel bed ways (12) disposed on the seat (11), a first motor (13) disposed at one end of the seat (11), a carriage (15) slidably disposed on the bed ways (12) and driven by the first motor (13) for translating the carriage (15) rectilinearly in a first direction on a horizontal plane parallel to the bed (19), the carriage (15) having a gable guard (16) at one end above the bed ways (12), and a second motor (18) disposed at the other side of the carriage (15);
a turret assembly (20) having a first slide (21) on the bottom, the first slide (21) being slidably mounted on the top of the carriage (15) and driven by the second motor (18) for translating the turret assembly (20) rectilinearly in a second direction on the horizontal plane parallel, the second direction being perpendicular to the first direction;
an L-shaped headstock (30) disposed on the bed (19) with its horizontal portion disposed above the carriage (15) and the turret assembly (20), the headstock (30) including a first chuck (31) on the vertical portion facing the turret assembly (20), a first hydraulic cylinder (32) disposed on the vertical portion opposite the first chuck (31), the first hydraulic cylinder (32) being adapted to activate the first chuck (31) to clamp one end of a workpiece, and a third motor (33) disposed at an open end of the horizontal portion; and
a tailstock (40) disposed under the horizontal portion of the headstock (30) and including a housing (41), a second chuck (43) disposed at one end of the housing (41) aligned with the first chuck (31), and a second hydraulic cylinder (42) disposed at the other end of the housing (41), the second hydraulic cylinder (42) being adapted to activate the second chuck (43) to clamp the other end of the workpiece, a second slide (45) disposed on the top of the housing (41), a threaded shaft (46) disposed through the second slide (45) to rotatably connect to the third motor (33), and two parallel racks (47) disposed between the second slide (45) and the bottom of the horizontal portion of the headstock (30) so that the tailstock (40) is adapted to translate rectilinearly along the first direction via the second slide (45) to cause the second chuck (43) to clamp the other end of the workpiece when the third motor (33) activates;
wherein chips machined from the workpiece are collected by the chip pan (14) after being deflected by the gable guard (16).

2. A turret lathe comprising:
a support structure (10) including a top bed (19) having a chip pan (14), a raised seat (11) disposed besides the chip pan (14), two parallel bed ways (12) disposed on the seat (11), a first motor (13) disposed at one end of the seat (11), a carriage (15) slidably disposed on the bed ways (12) and driven by the first motor (13) for translating the carriage (15) rectilinearly in a first direction on a horizontal plane parallel to the bed (19), the carriage (15) having a gable guard (16) at one end above the bed ways (12), and a second motor (18) disposed at the other side of the carriage (15);
a turret assembly (20) having a first slide (21) on the bottom, the first slide (21) being slidably mounted on the top of the carriage (15) and driven by the second motor (18) for translating the turret assembly (20) rectilinearly in a second direction on the horizontal plane, the second direction being perpendicular to the first direction;
an L-shaped headstock (30) disposed on the bed (19) with its horizontal portion disposed above the carriage (15) and the turret assembly (20), the headstock (30) including a first chuck (31) on the vertical portion facing the turret assembly (20), a first hydraulic cylinder (32) disposed on the vertical portion opposite the first chuck (31), the first hydraulic cylinder (32) being adapted to activate the first chuck (31) to clamp one end of a workpiece, and a third motor (33) disposed at an open end of the horizontal portion;
a tailstock (50) disposed under the horizontal portion of the headstock (30) and including a housing (51), a second chuck (53) disposed at one end of the housing (51) aligned with the first chuck (31), and a second hydraulic cylinder (52) disposed at the other end of the housing (51), the second hydraulic cylinder (52) being adapted to activate the second chuck (53) to clamp the other end of the workpiece, a second slide (54) disposed on the top of the housing (51), a first threaded shaft (55) disposed through the second slide (54), two parallel first racks (56) on the second slide (54), a third slide (57) slidably disposed on the first racks (56), two parallel second racks (59) disposed between the third slide (57) and the bottom of the horizontal portion of the headstock (30), and a second threaded shaft (58) disposed through the third slide (57) to rotatably connect to the third motor (33) wherein the third motor (33) is adapted to drive the second threaded shaft (58) to translate the third slide (57) rectilinearly in the first direction; and
a fourth motor (60) disposed at the other side of the third slide (57), the fourth motor (60) being adapted to drive the first threaded shaft (55) to translate the second slide (54) rectilinearly in the second direction;
wherein chips machined from the workpiece are collected by the chip pan (14) after being deflected by the gable guard (16).

3. The turret lathe of claim 2, further comprising a column (70) secured between the open end of the horizontal portion of the headstock (30) and the bed (19).
